(19) United States
(12) Patent Application Publication
(10) Pub. No.: US 2025/0229217 A1
(43) Pub. Date: Jul. 17, 2025

(54) System And Method for Direct Air Capture of CO2 or methane From Atmospheric or Underwater Vented Sources

(71) Applicant: Christopher L. Abeyta, Farmington, NM (US)

(72) Inventor: Christopher L. Abeyta, Farmington, NM (US)

(21) Appl. No.: 18/412,533

(22) Filed: Jan. 14, 2024

(51) Int. Cl. B01D 53/14

(52) U.S. Cl. CPC B01D 53/1475; B01D 53/1487; B01D 2257/504; B01D 2257/7025

(57) ABSTRACT

This disclosure may relate generally to systems, methods and devices for Direct Air Capturing of CO2 or methane from atmospheric or underwater vented sources.

### FIELD OF INVENTION

The subject of this disclosure may relate generally to systems, methods and devices for Direct Air Capturing of CO2 or Methane from atmospheric or underwater vented sources. For the purposes of this disclosure, the reference of methane is referred as several hydrocarbon chain compounds in gas or liquid that is commonly referred to as methane.

### BACKGROUND OF THE INVENTION

There is a growing concern, now international in scope, over the effects of global warming, caused significantly by industrial emissions of greenhouse gases (primarily Carbon dioxide [CO2], Methane [Ch4], etc.) into earth's troposphere.

Though natural forces can contribute to global warming, it has been estimated that the influence of industrial activities that emit greenhouse gases (significantly, processes that burn fossil fuels) have, since the onset of the industrial revolution (1760), contributed to a vast increase in the extent and pace of global warming. Such warming now poses the following deleterious impacts on weather patterns and events (climate change) and ecosystems: (1) expansion of deserts, replacing agriculturally fertile areas; (2) increased occurrence of heat waves, with consequent increases in wildfires; (3) in the Arctic, melting of permafrost, loss of sea ice, and glacial retreat—contributing to loss of wildlife habitat and increase in ocean temperatures, levels, and acidity; (4) increased frequency of intense, destructive storms (e.g., hurricanes, tornadoes, heavy rainfall, heavy snowfall); and (5) relocation or extinction of wildlife species.

Additionally, the pace at which the average global surface temperature of the earth is approaching the critical increase of 1.5 degrees Centigrade has the potential to radically affect human life. For example, food and water scarcities may result in famines and pandemics, heat waves may result in increased occurrences of heat exhaustion, extensive migration may occur from areas rendered uninhabitable, and/or inoperability or destruction of critical infrastructures may result in severe economic crises

Although several technologies to remove CO2 from industrial emissions are in various stages of development, at this point in time the prospects of these technologies becoming commercially available are limited by the following related factors: (1) lengthy timelines needed to develop these technologies to a stage where they are ready for commercial application, with estimates ranging from three to 20 years. (Regarding this point, it is emphasized that some assessments of the time remaining until the effects of global warming become irreversible are as brief as 20 years.); (2) lack of economic feasibility due mainly to prohibitive capital costs and high energy expenditures to remove CO2; and/or lack of financial incentives (e.g., Department of Energy grants) to fine tune presently developed processes and to develop new processes.

It is in the above-explained context that this patent application is being submitted to the Patent Office, a solution for cost effective direct air capture of CO2 or Methane from atmospheric or underwater vented sources.

### SUMMARY OF THE INVENTION

A system, method and devices are disclosed herein. In various embodiments, direct air capturing of vented CO2 or methane from a vent or pipe. The captured CO2 or methane is stored under pressure for utilization or sequestering.

A system, method and devices are disclosed herein. In various embodiments, direct air capturing of vented CO2 or methane from anywhere within earth's atmosphere. The captured CO2 or methane is stored under pressure for utilization or sequestering.

A system, method and devices are disclosed herein. In various embodiments, the capture of the CO2 or methane from underwater bodies i.e., rivers, lakes, aquifers etc.

### BRIEF DESCRIPTION OF THE DRAWINGS

These and other features, aspects, and advantages will become better understood with reference to the following description, claims and accompanying drawings where:

FIG. 1 illustrates, in various embodiments, direct air capturing of vented CO2 or methane from a vent or pipe. The captured CO2 or methane is stored under pressure for utilization or sequestering.

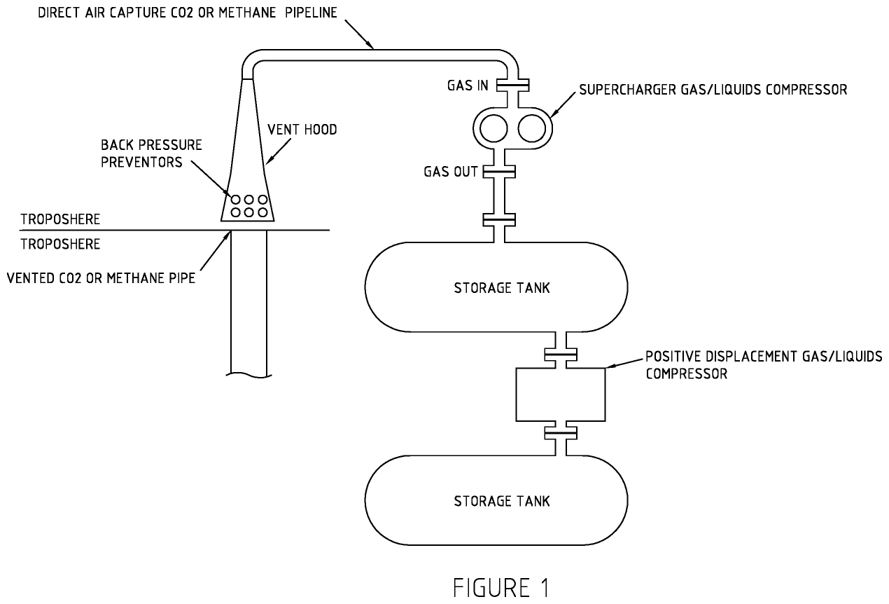

FIG. 2 illustrates, in various embodiments, direct air capturing of vented CO2 or methane from anywhere within earth's atmosphere. The captured CO2 or methane is stored under pressure for utilization or sequestering.

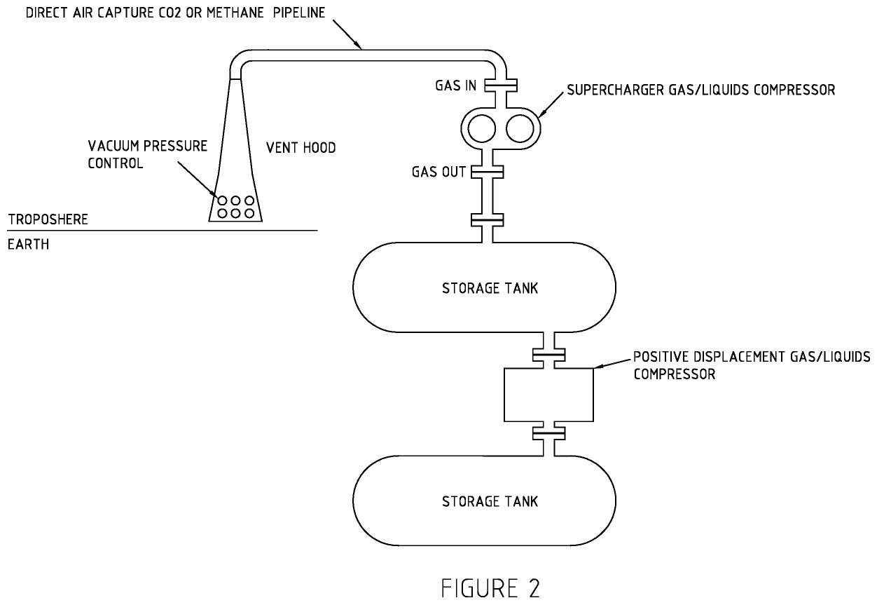

FIG. 3 illustrates, in various embodiments, direct air capturing of vented CO2 or methane from underwater. The captured CO2 or methane is stored under pressure for utilization or sequestering.

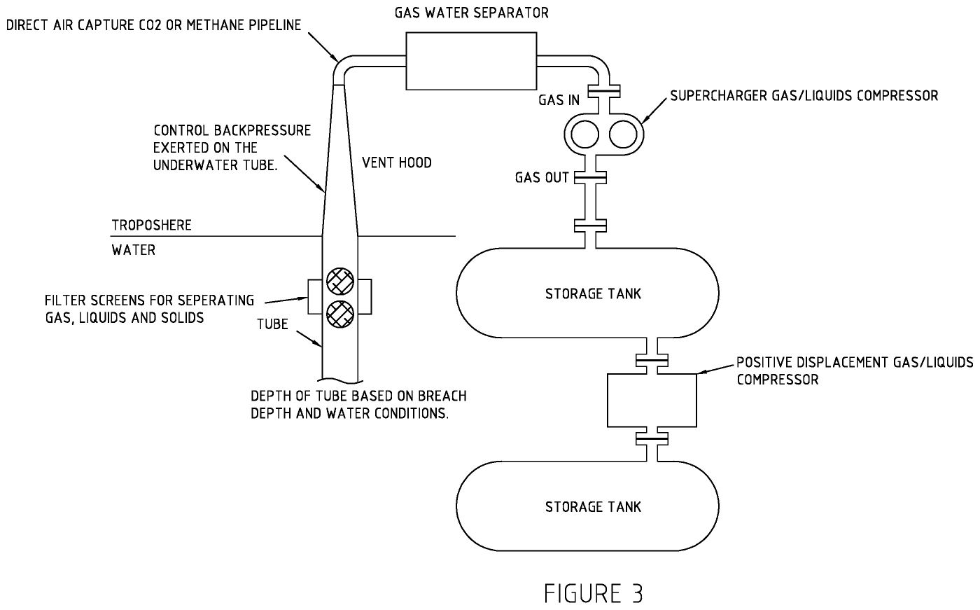

### DETAILED DESCRIPTION

The following descriptions are not intended as a limitation on the use or applicability of the invention, but instead, are provided merely to enable a full and complete description of exemplary embodiments.
Gas Conditioning plant venting CO2.
CO2 from enhanced oil recovery
CO2 from processes to capture CO2 for utilization and sequestering
Methane released from earth
Methane from permafrost
Methane released from caves from ice or earth.
The gas conditioning process's that want CO2 captured instead of venting into the atmosphere.
The typical Haber-Bosch fertilizer process vents the CO2 into the atmospheric air.
CO2 source is from the vented exhaust from a coal or diesel fired locomotive.

In accordance with the exemplary embodiments of the present invention, systems, methods and devices are not intended as a limitation on the use or applicability of the invention, but instead, are provided merely to enable a full and complete description of the exemplary embodiments.

It should be appreciated that the particular implementations shown and described herein are illustrative of various embodiments including its best mode and are not intended to limit the scope of the present disclosure in any way or are intended to represent all exemplary functional relationships possible.

While the principles of the disclosure have been shown in embodiments, many modifications of structure, arrangements, proportions, devices, materials and components, used in practice, which are particularly adapted for a specific environment and operating requirements without departing from the principles and scope of this disclosure. These and other changes or modifications are intended to be included within the scope of the present disclosure and may be expressed in the following claims.

I claim:

1. A System comprising:
Direct air capture and storage of CO2 or Methane from a pipe venting CO2 or methane into earth's atmosphere.

2. The vent hood device of claim 1, wherein is configured to prevent backpressure in the vented pipe or vent.

3. The supercharger gas/liquids device of claim 1, wherein is configured to be driven from renewable energy.

4. The positive displacement gas/liquids compressor device of claim 1, wherein is configured to be driven from renewable energy.

5. A System comprising:
Direct air capture and storage of CO2 or Methane from anywhere on earth venting CO2 or methane into earth's atmosphere.

6. The vent hood device of claim 5, wherein is configured to control the vacuum pressure.

7. The supercharger gas/liquids device of claim 5, wherein is configured to be driven from renewable energy.

8. The positive displacement gas/liquids compressor device of claim 5, wherein is configured to be driven from renewable energy.

9. A System comprising:
Direct air capture and storage of CO2 or Methane from under the water before it enters into earth's atmosphere.

10. The vent hood device of claim 9, wherein is configured to prevent to control the backpressure exerted on the underwater tube.

11. The supercharger gas/liquids device of claim 9, wherein is configured to be driven from renewable energy.

12. The positive displacement gas/liquids compressor device of claim 9, wherein is configured to be driven from renewable energy.
